(19) United States
(12) Patent Application Publication
(10) Pub. No.: US 2025/0287876 A1
(43) Pub. Date: Sep. 18, 2025

(54) WORK MACHINE

(71) Applicant: Kubota Corporation, Osaka-shi (JP)

(72) Inventors: Kazuo SAKAGUCHI, Sakai-shi (JP); Tetsuya FUJIWARA, Sakai-shi (JP)

(21) Appl. No.: 19/222,424

(22) Filed: May 29, 2025

Related U.S. Application Data
(63) Continuation of application No. PCT/JP2022/048215, filed on Dec. 27, 2022.

(51) Int. Cl. A01D 75/28; B64U 10/60; B64U 101/40

(52) U.S. Cl. CPC A01D 75/28; B64U 10/60; B64U 2101/40

(57) ABSTRACT

A work machine includes a work apparatus configured to perform work on a ground surface, an aerial vehicle configured to fly by generating thrust, a connection mechanism configured to connect the work apparatus and the aerial vehicle, and a posture controller configured or programmed to control at least one of the aerial vehicle or the connection mechanism to control a posture of the work apparatus.

### CROSS REFERENCE TO RELATED APPLICATIONS

This application is a Continuation Application of PCT Application No. PCT/JP2022/048215 filed on Dec. 27, 2022. The entire contents of this application are hereby incorporated herein by reference.

### BACKGROUND OF THE INVENTION

### 1. Field of the Invention

The present invention relates to work machines including aerial vehicles and work apparatuses.

### 2. Description of the Related Art

In recent years, the efficiency of agricultural work using an aerial vehicle such as a drone has been considered. International Publication No. 2020/137242 discloses a support device for an aerial vehicle on which a spraying device that sprays pesticides or the like is mounted, as an example of agricultural work.

### SUMMARY OF THE INVENTION

In a case where an aerial vehicle is utilized for agricultural work, there is a demand for a work machine that can perform work appropriately.

A work machine according to an example embodiment of the present invention includes a work apparatus configured to perform work on a ground surface, an aerial vehicle configured to fly by generating thrust, a connection mechanism configured to connect the work apparatus and the aerial vehicle, and a posture controller configured or programmed to control at least one of the aerial vehicle or the connection mechanism to control a posture of the work apparatus.

According to the above-described example embodiment, since the posture of the work apparatus is controlled by the control of at least one of the aerial vehicle or the connection mechanism, it is possible to appropriately perform work on the ground surface.

In an example embodiment of the present invention, it is preferable that the connection mechanism may include a release mechanism configured to disconnect the aerial vehicle from the work apparatus while the aerial vehicle is flying.

According to the above-described example embodiment, since the connection between the aerial vehicle and the work apparatus can be released during the flight, it is possible to reduce the possibility of a crash of the aerial vehicle. For example, in a case where it is difficult to control the posture of the aerial vehicle due to a gust or the like, it is possible to avoid a crash by reducing the load of the flight by the release of the connection.

In an example embodiment of the present invention, it is preferable that the connection mechanism may include a buffer mechanism configured to buffer an impact from the work apparatus.

According to the above-described example embodiment, since the impact from the work apparatus is cushioned, the possibility of damage to the connection device and the aerial vehicle is reduced.

In an example embodiment of the present invention, it is preferable to further include an inclination acquirer configured to acquire inclination information indicating an inclination of the ground surface, and it is preferable that the posture controller may be configured or programmed to control the posture of the work apparatus according to the inclination information acquired by the inclination acquirer.

According to the above-described example embodiment, since the posture of the work apparatus is controlled according to the inclination of the ground surface, it is possible to more appropriately perform work on the ground surface.

In an example embodiment of the present invention, it is preferable that the connection mechanism may include a change mechanism configured to change a distance between the aerial vehicle and the work apparatus, and the posture controller may be configured or programmed to control the posture of the work apparatus by operating the change mechanism according to the inclination information acquired by the inclination acquirer.

According to the above-described example embodiment, since the change mechanism is operated according to the inclination of the ground surface and the posture of the work apparatus is controlled, it is possible to more appropriately perform the work on the ground surface.

In an example embodiment of the present invention, it is preferable that the work apparatus may include a thrust generator configured to press the work apparatus against the ground surface.

According to the above-described example embodiment, since the work apparatus is pressed against the ground surface by the thrust generator, it is possible to more appropriately perform work on the ground surface.

In an example embodiment of the present invention, it is preferable to further include an inclination acquirer configured to acquire inclination information indicating an inclination of the ground surface, and a thrust controller configured or programmed to control the thrust generator according to the inclination information acquired by the inclination acquirer.

According to the above-described example embodiment, since the thrust generator is controlled according to the inclination of the ground surface, the work apparatus is further appropriately pressed against the ground surface, making it possible to appropriately perform work on the ground surface.

In an example embodiment of the present invention, it is preferable that a direction of thrust generated by the thrust generator may be different from a direction of the thrust of the aerial vehicle.

According to the above-described example embodiment, the work apparatus can be pressed by the thrust generator in a direction in which the work apparatus cannot be pressed by the thrust of the aerial vehicle. Accordingly, it is possible to more appropriately perform work on the ground surface.

In an example embodiment of the present invention, it is preferable that the thrust generator may include a main propeller configured to be driven to generate thrust, and a protective structure around the main propeller.

According to the above-described example embodiment, since the protective structure is provided around the propeller, the damage to the propeller is reduced or prevented.

In an example embodiment of the present invention, it is preferable that the thrust generator may include a main propeller configured to be driven to generate thrust, and a sub-propeller rotatable by receiving at least a portion of downwash from the aerial vehicle, and the thrust generator may be configured to use energy received by the sub-propeller from the downwash to drive the main propeller.

According to the above-described example embodiment, since the downwash from the aerial vehicle is utilized to drive the main propeller of the thrust generator, the energy efficiency can be improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view illustrating the outline of a work machine.

FIG. 2 is a block diagram illustrating a configuration related to the control of the work machine.

FIG. 3 is a side view illustrating the outline of the work machine.

FIG. 4 is a block diagram illustrating a configuration related to the control of the work machine.

### DETAILED DESCRIPTION OF THE EXAMPLE EMBODIMENTS

Hereinafter, work machines according to example embodiments of the present invention will be described with reference to the drawings. The present invention is not limited to the following example embodiments, and various modifications can be made without departing from the scope of the present invention.

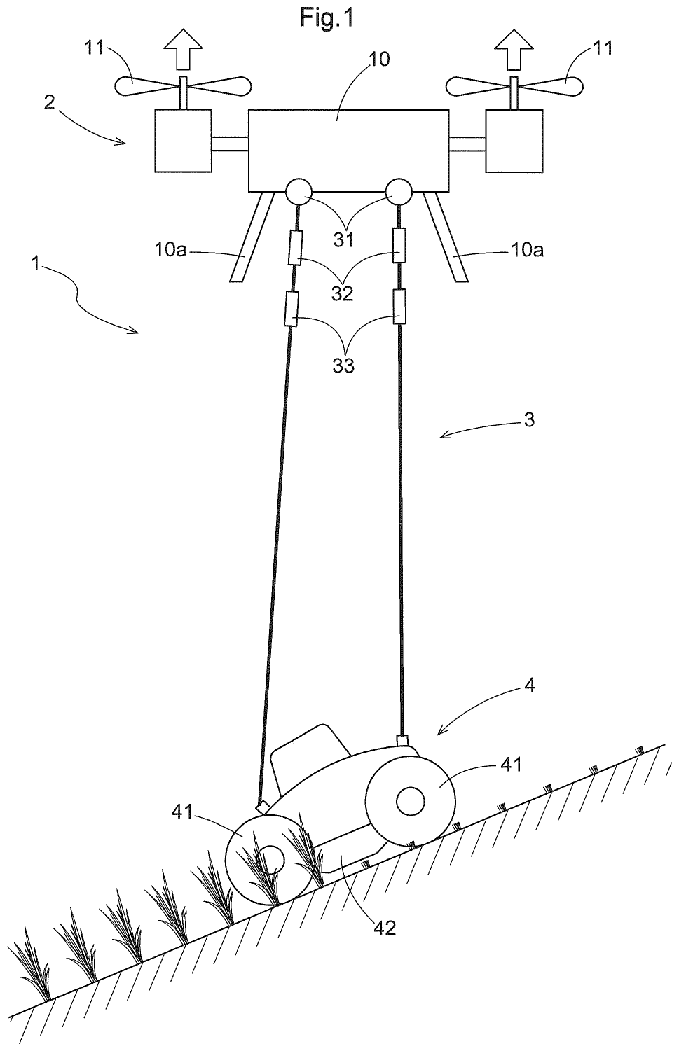

FIG. 1 illustrates a work machine 1. The work machine 1 is configured to be capable of executing agricultural work while flying.

The work machine 1 includes an aerial vehicle 2, a connection mechanism 3, and a work apparatus 4.

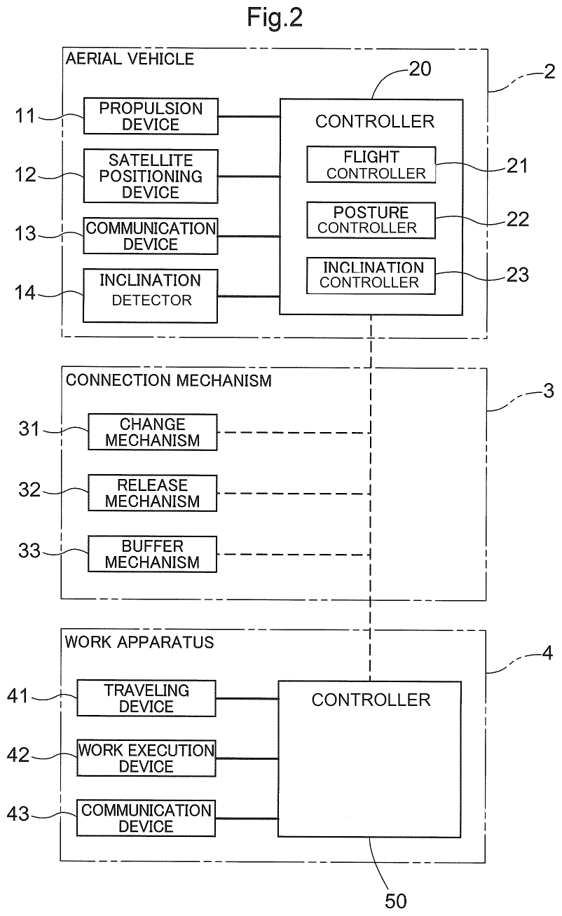

The aerial vehicle 2 generates thrust to fly. As illustrated in FIGS. 1 and 2, an airframe 10 of the aerial vehicle 2 includes legs 10a for landing, a propulsion device 11, a satellite positioning device 12, a communication device 13, an inclination detector 14, and a controller 20.

The propulsion device 11 is a propeller that is driven and rotated. A drive source of the propulsion device 11 may be an engine or an electric motor. The number of propulsion devices 11 is preferably three or more, and may be four, five, six, or seven or more, for example. The airframe 10 may include a plurality of types of propulsion devices 11 having different sizes and outputs. The satellite positioning device 12 receives a

positioning signal from an artificial satellite used in a global navigation satellite system (GNSS, for example, GPS, QZSS, Galileo, GLONASS, BeiDou, or the like). Then, the satellite positioning device 12 generates positioning data indicating the own position of the work machine 1 based on the received positioning signal.

The communication device 13 communicates with a remote controller held by an operator or a higher-level farming system. In addition, the communication device 13 communicates with the communication device 43 of the work apparatus 4.

The inclination detector 14 is a sensor that detects the inclination of the ground surface. The inclination detector 14 is LiDAR or a camera, for example. The inclination detector may be an IMU sensor or a device that physically brings a probe into contact with the ground surface to detect the inclination. The inclination detector 14 detects the inclination of the ground surface on which the work apparatus 4 performs work, and generates data indicating the inclination of the ground surface.

The controller 20 is configured or programmed to control the operations of the aerial vehicle 2, the connection mechanism 3, and the work apparatus 4. That is, the controller 20 is configured or programmed to control the overall operation of the work machine 1.

The controller 20 includes a memory (such as an HDD or a non-volatile RAM, not illustrated) that stores a program corresponding to functional modules described below, and a CPU (not illustrated) that executes the program. The functions of each functional unit are realized by executing the program by the CPU. That is, the controller 20 includes a non-transitory recording medium that stores the program.

The controller 20 may include one or a plurality of ECUs mounted on the aerial vehicle 2. In addition, the controller 20 may include one or a plurality of ECUs mounted on the work machine 1.

The controller 20 is configured or programmed to include a flight controller 21, a posture controller 22, and an inclination acquirer 23 as the functional modules. The functions and operations of these functional modules will be described below.

The connection mechanism 3 connects the work apparatus 4 and the aerial vehicle 2. The connection mechanism 3 includes a change mechanism 31, a release mechanism 32, and a buffer mechanism 33. In the present example embodiment, the change mechanism 31, the release mechanism 32, and the buffer mechanism 33 are connected by flexible wires. Four wires connect the work apparatus 4 and the aerial vehicle 2, for example. In other words, an upper end of the connection mechanism 3 is connected to the aerial vehicle 2, and a lower end of the connection mechanism 3 is connected to the work apparatus 4.

The connection mechanism 3 may be operated by power (power from a battery or power generated by an engine) supplied from the aerial vehicle 2. The connection mechanism 3 may be operated by power (power from a battery or power generated by an engine) supplied from the work apparatus 4.

The change mechanism 31 changes the posture of the work apparatus 4 with respect to the aerial vehicle 2 by changing the total length (that is, the distance between the aerial vehicle 2 and the work apparatus) of the connection mechanism 3. Specifically, the change mechanism 31 is a winch that winds and unwinds the wires. The change mechanism 31 is attached to a lower portion of the airframe 10 of the aerial vehicle 2.

The release mechanism 32 releases the connection between the aerial vehicle 2 and the work apparatus 4 during the flight of the aerial vehicle 2. Specifically, the release mechanism 32 is a mechanism that can be separated into an upper portion and a lower portion by the operation of an electromagnet, a solenoid, an actuator, or the like controlled by the controller 20. The release mechanism 32 may be a mechanism that cuts a wire with a blade. The release mechanism 32 is provided in an intermediate portion of the connection mechanism 3.

The buffer mechanism 33 buffers the impact from the work apparatus 4. Specifically, the buffer mechanism 33 is a mechanism that attenuates a force received by the connection mechanism 3 from the work apparatus 4. For example, the buffer mechanism 33 is a mechanism that can be deformed according to the force received from the work apparatus 4, and is an elastic structure such as a spring or a damper.

The work apparatus 4 is an apparatus that can perform work on the ground surface. In the present example embodiment, the work apparatus 4 is a mower. The work apparatus 4 may be a cultivator, a seedling planter, a seeder, a chemical sprayer, a harvester, a granular chemical feeder, a fertilizer applicator, or the like. In the example of FIG. 1, the ground surface is inclined, but work may be performed on a horizontal ground surface.

In the present example embodiment, the work apparatus 4 includes a traveling device 41, a work execution device 42, a communication device 43, and a controller 50.

The traveling device 41 is a device that causes the work apparatus 4 to travel in contact with the ground surface. In the present example embodiment, the traveling device 41 is a driven wheel. The traveling device 41 may be a crawler-type traveling device or a leg-type traveling device.

The work execution device 42 is a device that actually performs work on the ground surface. In the present example embodiment, the work execution device 42 is a cutting blade. The work execution device 42 may be a cultivating device, a seedling planting device, a seeding device, a spraying device (a chemical, a granular chemical, or a fertilizer), or a harvesting device.

The communication device 43 communicates with the communication device 13 of the aerial vehicle 2.

The controller 50 is configured or programmed to control the operation of the work apparatus 4.

The controller 50 includes a memory (such as an HDD or a non-volatile RAM, not illustrated) that stores a program corresponding to the functional modules, and a CPU (not illustrated) that executes the program. The functions of each functional unit are realized by executing the program by the CPU. That is, the controller 50 includes a non-transitory recording medium that stores a program.

The controller 50 may include one or a plurality of ECUs mounted on the work apparatus 4.

The work apparatus 4 may include an engine, a fuel tank, and a battery as a power source. The work apparatus 4 may be operated by a battery mounted on the work apparatus 4 or may be operated by power supplied from the aerial vehicle 2. Examples of methods for supplying power from the aerial vehicle 2 to the work apparatus 4 include power supply by an electric wire provided along the connection mechanism 3, and wireless power supply, or the like.

As illustrated in FIG. 2, the propulsion device 11, the satellite positioning device 12, the communication device 13, the inclination detector 14, the change mechanism 31, the release mechanism 32, the buffer mechanism 33, and the controller 50 of the work apparatus 4 are connected to the controller 20 of the aerial vehicle 2. The controller 20 is configured or programmed to control these devices to cause the work machine 1 to execute flight and work (agricultural work or the like). In the present example embodiment, the work is mowing the ground surface.

The flight controller 21 is configured or programmed to control the propulsion device 11 to cause the work machine 1 to fly. The flight controller 21 may cause the work machine 1 to fly according to an operation received by the remote controller held by the operator. The flight controller 21 may cause the work machine 1 to fly according to a flight plan stored in advance in the memory. The flight controller 21 may cause the work machine 1 to fly based on the flight plan received from the higher-level farming system.

The posture controller 22 is configured or programmed to control at least one of the aerial vehicle 2 and the connection mechanism 3 to control the posture of the work apparatus 4. Hereinafter, this will be described in details.

The posture controller 22 is configured or programmed to control the aerial vehicle 2 to control the posture of the work apparatus 4. In a case where the inclination of the aerial vehicle 2 with respect to the ground surface changes without changing the length of the connection mechanism 3, the inclination of the work apparatus 4 with respect to the ground surface also changes. That is, the posture controller 22 is configured or programmed to control the posture (the inclination with respect to the ground surface) of the work apparatus 4 by controlling the inclination of the aerial vehicle 2 with respect to the ground surface.

The posture controller 22 is configured or programmed to control the connection mechanism 3 to control the posture of the work apparatus 4. In a case where the length (the length of some of the plurality of wires) of the connection mechanism 3 changes in a state in which the inclination of the aerial vehicle 2 with respect to the ground surface is constant, the inclination of the work apparatus 4 with respect to the ground surface changes. That is, the posture controller 22 controls the posture (inclination with respect to the ground surface) of the work apparatus 4 by operating the change mechanism 31 to control the length of the connection mechanism 3.

The posture controller 22 may control only one of the aerial vehicle 2 or the connection mechanism 3, or may control both the aerial vehicle 2 and the connection mechanism 3.

The inclination acquirer 23 acquires inclination information indicating the inclination of the ground surface. In the present example embodiment, the inclination acquirer 23 acquires the inclination information indicating the inclination of the ground surface based on the output of the inclination detector 14.

The inclination acquirer 23 may acquire the inclination information indicating the inclination of the ground surface regardless of the output of the inclination detector 14. For example, the inclination detector 14 may acquire the inclination information indicating the inclination of the ground surface based on positioning data output by the satellite positioning device 12 and map data indicating the inclination of the ground surface. In this case, the work machine 1 may not include the inclination detector 14.

The posture controller 22 may be configured or programmed to control the posture of the work apparatus 4 according to the inclination information acquired by the inclination acquirer 23. Specifically, the posture controller 22 is configured or programmed to control the posture of the work apparatus 4 such that the posture of the work apparatus 4 with respect to the ground surface is suitable for work. For example, the posture controller 22 is configured or programmed to control the posture of the work apparatus 4 such that the posture of the work apparatus 4 is parallel to the ground surface.

The posture controller 22 may control the posture of the work apparatus 4 such that the distance between the ground surface and the work apparatus 4 is suitable for work.

The posture controller 22 may be configured or programmed to perform control as follows. A sensor (the inclination detector 14 may also be used) such as a camera or a LiDAR provided in the aerial vehicle 2 detects the work result of the work apparatus 4. The posture controller 22 is configured or programmed to control the posture of the work apparatus 4 according to the work result detected by the sensor. For example, the posture controller 22 is configured or programmed to control the posture of the work apparatus 4 such that the work result is improved in a case where the work result is worse than a preset reference.

An example of the work result will be described. In a case where the work apparatus 4 is a mower, the work result is the height of remaining cut grass.

In a case where the work apparatus 4 is a seedling planter, the work result is planting depth, or the presence or absence of missing stalks (missing seedlings).

In a case where the work apparatus 4 is a seeder, a fertilizer applicator, a chemical sprayer, or a granular chemical feeder, the work result is a supply position, the degree of exposure of supplied seeds, fertilizer, chemical, and the like from the soil surface, a spraying range, and the like.

In a case where the work apparatus 4 is a harvester, the work result is a harvest residue (presence or absence of unharvested crops) or the like.

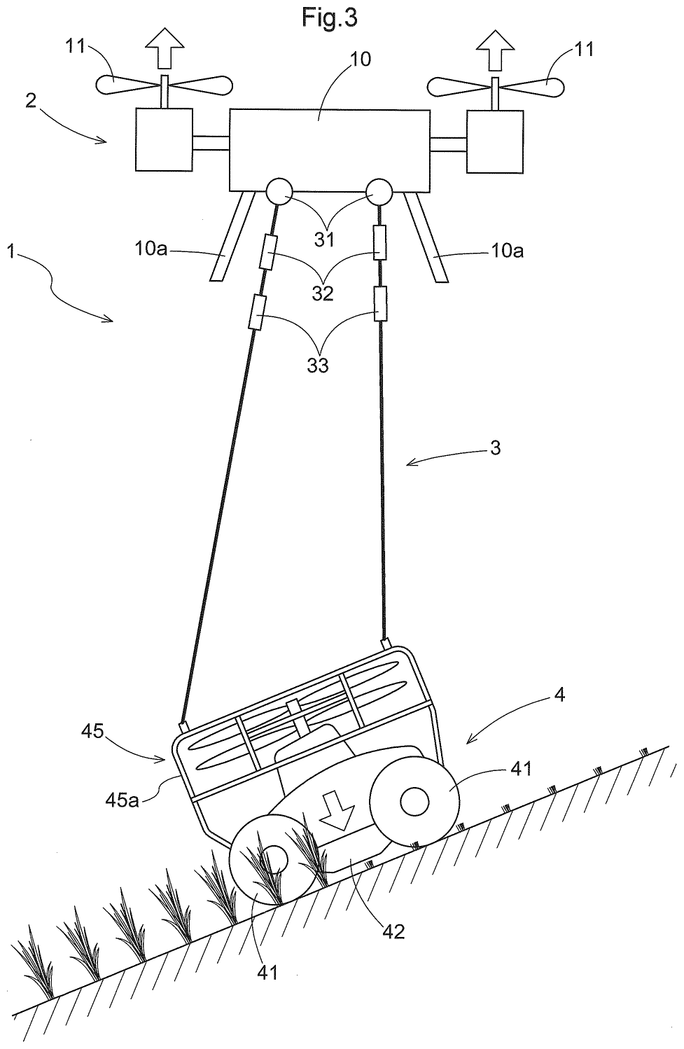

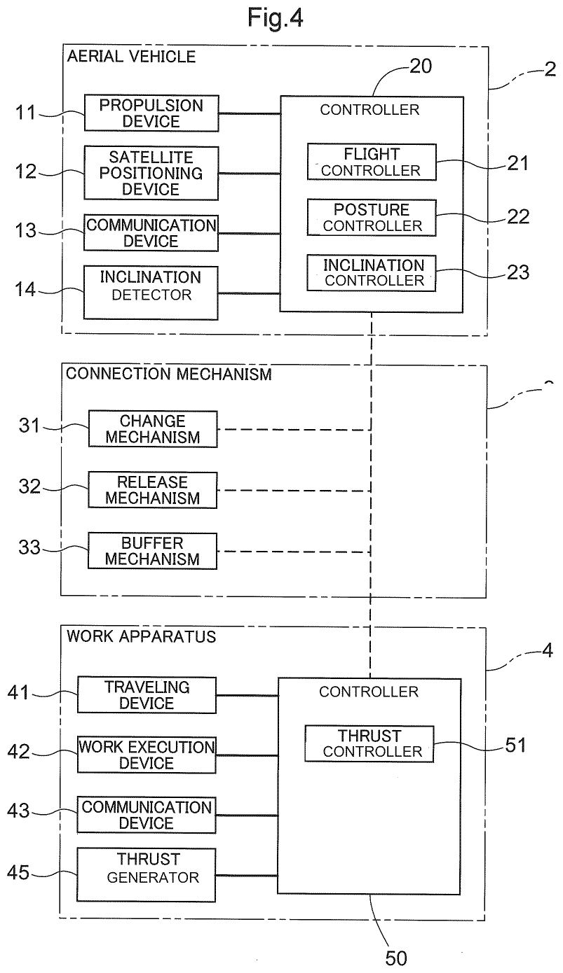

Another example embodiment of the present invention will be described with reference to FIGS. 3 and 4. In the following description, the same reference numerals are assigned to the same components as those in the above-described example embodiment, and the description thereof may be omitted.

In the work machine 1 of the present example embodiment, the work apparatus 4 includes a thrust generator 45. The controller 50 includes a thrust controller 51.

The thrust generator 45 generates thrust to press the work apparatus 4 against the ground surface. In the present example embodiment, the thrust generator 45 includes a propeller (an example of a “main propeller”) that is driven and rotated. The number of thrust generators 45 may be two as in the illustrated example, or may be one or three or more. The plurality of thrust generators 45 may be arranged coaxially as in the illustrated example, or may be arranged on different rotation axes. The work apparatus 4 may include a plurality of types of thrust generators 45 having different sizes and outputs.

The thrust generator 45 may be driven by power of a PTO shaft branching from a drive shaft from the engine of the work apparatus 4. In this case, a clutch is provided between the engine and the thrust generator 45, and the drive of the thrust generator 45 is turned on and off.

The thrust generator 45 may be driven by an electric motor. In this case, examples of methods for supplying power to the electric motor include wired power supply from the work apparatus 4, wired power supply from the aerial vehicle 2 by an electric wire provided along the connection mechanism 3, and wireless power supply from the aerial vehicle 2.

In the present example embodiment, the direction of the thrust generated by the thrust generator 45 is different from the direction of the thrust of the aerial vehicle 2. As illustrated by a white arrow in FIG. 3, the direction of the thrust of the aerial vehicle 2 is upward (upward in an up-down direction of the airframe 10 of the aerial vehicle 2). The direction of the thrust of the thrust generator 45 is downward (downward in the up-down direction of the airframe of the work apparatus 4). The thrust generator 45 may be configured such that the direction of the thrust can be changed. For example, the rotation axis of the thrust generator 45 may be swingable.

In addition, the work apparatus 4 includes a protective body 45a. The protective body 45a is disposed around the propeller which is the thrust generator 45. In the present example embodiment, the protective body 45a is a basket-shaped structure formed by bending a rod. The protective body 45a may include a mesh-shaped structure or may include a plate-shaped structure. The protective body 45a may cover a portion of the thrust generator 45. It is preferable that the protective body 45a covers the entire side surface of the thrust generator 45. It is preferable that the protective body 45a covers the entire upper surface of the thrust generator 45. It is preferable that the protective body 45a covers the entire lower surface of the thrust generator 45.

The thrust controller 51 is configured or programmed to control the thrust generator 45 according to the inclination information acquired by the inclination acquirer 23. For example, the thrust controller 51 is configured or programmed to control the thrust controller 51 such that the thrust increases as the inclination of the ground surface increases. The thrust controller 51 may stop the thrust generator 45 in a case where the inclination of the ground surface is smaller than a predetermined threshold value.

The thrust controller 51 may be able to control the direction of the thrust generated by the thrust generator 45. For example, the thrust controller 51 may control the thrust generator 45 such that the direction of the thrust generated by the thrust generator 45 is perpendicular to the ground surface based on the inclination information acquired by the inclination acquirer 23.

The thrust generator 45 may include a sub-propeller (not illustrated) that receives at least a portion of the downwash from the aerial vehicle 2 and rotates in addition to the propeller (main propeller) that is driven to generate the thrust. The thrust generator 45 may be configured to use the energy received by the sub-propeller from the downwash to drive the main propeller. In this case, it is preferable that the shape of the sub-propeller is a shape that is easily rotated by receiving the downwash from the aerial vehicle 2 located above the work apparatus 4. For example, a generator may be connected to the sub-propeller, and the power generated by the generator may be used for driving the main propeller.

The present invention is not limited to the configurations exemplified in the above-described example embodiments. Hereinafter, other example embodiments of the present invention will be described.

In the above-described example embodiments, an example in which the connection mechanism 3 includes the flexible wires has been described. The entire connection mechanism 3 may include rigid bodies. In this case, the change mechanism 31 may be a mechanism that is extended and retracted to change the length or a mechanism that bends to change a connection angle.

The connection mechanism 3 may not include the release mechanism 32.

The connection mechanism 3 may not include the buffer mechanism 33.

The controller 20 may not include the inclination acquirer 23.

The work apparatus 4 may not include the protective body 45a.

The work apparatus 4 may be replaceable with substitutes capable of executing different types of work.

The form of the aerial vehicle 2 may be different from that of the above-described example embodiments. For example, the propulsion device 11 may include a main rotor and a sub-rotor. The number of main rotors may be one or two or more. The number of sub-rotors may be one or two or more. The main rotor may be driven by an engine, and the sub-rotor may be driven by an electric motor. The aerial vehicle 2 may include a battery that stores the power generated by the engine.

Example embodiments of the present invention are applicable to work machines that execute work while flying.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work machine, comprising:
a work apparatus configured to perform work on a ground surface;
an aerial vehicle configured to fly by generating thrust;
a connection mechanism configured to connect the work apparatus and the aerial vehicle; and
a posture controller configured or programmed to control at least one of the aerial vehicle or the connection mechanism to control a posture of the work apparatus.

2. The work machine according to claim 1, wherein the connection mechanism includes a release mechanism configured to disconnect the aerial vehicle from the work apparatus while the aerial vehicle is flying.

3. The work machine according to claim 1, wherein the connection mechanism includes a buffer mechanism configured to buffer an impact from the work apparatus.

4. The work machine according to claim 1, further comprising:
an inclination acquirer configured to acquire inclination information indicating an inclination of the ground surface; wherein
the posture controller is configured or programmed to control the posture of the work apparatus according to the inclination information acquired by the inclination acquirer.

5. The work machine according to claim 4, wherein
the connection mechanism includes a change mechanism configured to change a distance between the aerial vehicle and the work apparatus; and
the posture controller is configured or programmed to control the posture of the work apparatus by operating the change mechanism according to the inclination information acquired by the inclination acquirer.

6. The work machine according to claim 1, wherein the work apparatus includes a thrust generator configured to press the work apparatus against the ground surface.

7. The work machine according to claim 6, further comprising:
an inclination acquirer configured to acquire inclination information indicating an inclination of the ground surface; and
a thrust controller configured or programmed to control the thrust generator according to the inclination information acquired by the inclination acquirer.

8. The work machine according to claim 6, wherein a direction of thrust generated by the thrust generator is different from a direction of the thrust of the aerial vehicle.

9. The work machine according to claim 6, wherein the thrust generator includes a main propeller configured to be driven to generate thrust, and a protective structure around the main propeller.

10. The work machine according to claim 6, wherein
the thrust generator includes a main propeller configured to be driven to generate thrust, and a sub-propeller rotatable by receiving at least a portion of downwash from the aerial vehicle; and
the thrust generator is configured to use energy received by the sub-propeller from the downwash to drive the main propeller.
